(19) United States
(12) Patent Application Publication
(10) Pub. No.: US 2005/0104703 A1
(43) Pub. Date: May 19, 2005

(54) Transformer core, transformer, and method of production thereof

(75) Inventors: Masahiko Watanabe, Tokyo (JP); Shigeru Katou, Tokyo (JP); Yuji Sezai, Tokyo (JP); Katsushi Yasuhara, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 10/988,554

(22) Filed: Nov. 16, 2004

(30) Foreign Application Priority Data
Nov. 17, 2003 (JP) 2003-386302

(51) Int. Cl. H01F 17/06

(52) U.S. Cl. 336/83

(57) ABSTRACT

A transformer core having a high inductance, small inductance tolerance, and small harmonic distortion, in particular total harmonic distortion (THD), wherein a surface roughness of a gap forming surface (RaG) forming a gap for adjustment of the inductance is not more than 0.70 μm, preferably not more than 0.45 μm, a transformer using the same, and a method of production of a transformer core having the above properties polishing the gap forming surface forming the gap by a grinding wheel having polishing abrasives of a particle size of #400 to #8000, preferably #600 to #8000 (JIS-R6001).

### BACKGROUND OF THE INVENTION

1. Field of the Invention

The present invention relates to a transformer core and a transformer using the same, more particularly relates to a transformer core with little harmonic distortion suitable for a transmission use transformer in various communications equipment etc. and a transformer using the same.

2. Description of the Related Art

As the core of a transmission system transformer or a power transformer, generally a core made or ferrite is being used. This is because ferrite, compared with other soft magnetic metal materials, has a smaller drop in initial magnetic permeability and power lose in the high frequency band and can be manufactured inexpensively.

In recent years, in the field of electronic equipment, demand has been rising for smaller, thinner, and higher performance electronic equipment. To meet these demands, attempts are being made to improve the performance of the cores of transformers made from ferrite.

For example, Japanese Patent Publication (A) No. 11-260652 discloses a ferrite core having a core structure comprised of a center leg, outer legs, and a bottom connecting these legs, having the outer legs slightly longer than the center leg, and having a difference in height of the highest point of the front end faces of the outer legs and the lowest point of the front end face of the center leg reduced to not more than 0.3 μm by mirror polishing.

This publication describes that it is possible to sufficiently reduce the air gap formed at the mating surfaces when combining a plurality of ferrite cores to form a transformer or inductor core and that a high inductance can be realized.

Further, Japanese Patent Publication (A) No. 5-299279 discloses a transformer core obtained by combining facing ground surfaces wherein the facing ground surfaces are joined with a spinel magnetic layer including iron atoms or alkoxy groups and exhibiting a spinel structure interposed between them.

This publication describes that by configuring the transformer core in this way, it is possible to prevent leakage of flux and improve the magnetic permeability.

On the other hand, when using a transformer core in a power transformer etc., the loss becomes a problem. When using a transformer core as a transmission system transformer, however, not only the loss, but also the harmonic distortion has to be reduced. It would however be difficult to obtain a transformer core having a small harmonic distortion such as sought when used as a communications use transmission system transformer from the above publications.

Further, in the field of communications equipment, there is growing demand for systems able to transfer huge amounts of data at a high speed. As technology enabling high speed transfer, xDSL (x Digital Subscriber Line) technology is spreading. As xDSL technology, there are ADSL (Asymmetric. Digital Subscriber Line) or VDSL (very High-Bit-Rate Digital subscriber Line) technology etc.

In xDSL technology, a modem is required for converting digital signals and analog signals. This modem requires a transmission system transformer for insulation from the line. As a transmission system transformer used for such xDSL technology, one is sought which has a high inductance in a wide frequency band and which maintains the reproducibility and communications rate of the transmission signal by having a small total harmonic distortion (THD) when transmitting the signal through the transformer. Here, the total harmonic distortion (THD) is expressed as a ratio between the sum of the effective values of the harmonic components and the effective value of the basic wave and is calculated by the following equation (1).
THD(dB)=20×log[(harmonic+noise)/(basic wave+harmonic+noise)] (1)

Japanese Patent Publication (A) No. 2003-297641 discloses an electronic device for a communications apparatus using a core comprised of a legged-core formed with outer legs and an inner leg and a core to be brought into abutment with that legged core wherein the mean roughness Ra of the center line of the mating surfaces of the cores is reduced to 1.2 μm or less.

According to this publication, by reducing the mean roughness of the center line between the mating surfaces of the cores to 1.2 μm or less, it is possible to reduce the THD_{F} (THD_{F} being the value of the THD divided by the amplitude permeability μa). However, this publication reduces the surface roughness for the purpose of reducing the THD_{F} (or THD). The surface roughness is only reduced for the mating surfaces. The invention of this publication cannot really be said to sufficiently reduce the THD_{F} (or THD).

To reduce the harmonic distortion at different frequencies, it is necessary to reduce the hysteresis loss of the ferrite core under the excitation conditions of the transformer or improve the linearity of the magnetization curve in the B-H curve. In a ferrite core, reduction of the hysteresis loss is particularly important for reducing the harmonic distortion.

### SUMMARY OF THE INVENTION

An object of the present invention is to provide a transformer core having a high inductance, a small inductance tolerance, and a small harmonic distortion and a transformer using the same. Another object of the present invention is to provide a method of production of a transformer core having the above properties.

The inventors took note of the surface roughness of the gap forming surface (RaG) forming a gap for the purpose of adjusting the inductance and discovered that by making the surface roughness of the gap forming surface (RaG) within a predetermined range, it was possible to keep the inductance high, reduce the inductance tolerance, and reduce the harmonic distortion, in particular the total harmonic distortion (THD) and thereby completed the present invention.

That is, according to a first aspect of the present invention, there is provided a transformer core having a gap for adjustment of the inductance, characterized in that the surface roughness of the gap forming surface (RaG) forming the gap is RaG≦0.70 μm.

According to the first aspect of the invention, by making the surface roughness of the gap forming surface (RaG) the above range in a transformer core (split type or nonsplit type) having a gap forming surface for forming a gap, a transformer core having a high inductance, a small inductance tolerance, and a small harmonic distortion is obtained.

According to a second aspect of the invention, there is provided a split transformer core having reference surfaces and a gap forming surface and having a gap of the difference in height between the reference surfaces and the gap forming surface, characterized in that the surface roughness of the gap forming surface (RaG) forming the gap is RaG≦0.70 μm.

According to the second aspect of the invention, by making the surface roughness of the gap forming surface (RaG) in the above range in a split transformer core using the reference surfaces of a transformer core of the present invention and the reference surfaces of another transformer core in combination, a transformer core having a high inductance, a small inductance tolerance, and a small harmonic distortion is obtained. Note that the other transformer core may or may not be a transformer core of the present invention.

Note that it has been known that there is a correlation between the magnitude of inductance and the depth of a gap. In split transformer cores, the gap of the transformer core has been processed to adjust the inductance.

Further, in the past, for the purpose of reducing the harmonic distortion, the reference surfaces contacting the other core directly (mating surfaces) have been mirror polished to reduce the surface roughness.

However, the gap forming surface formed when making the gap does not directly contact the other core. The purpose is control of the gap depth to adjust the inductance to a predetermined value. It has been considered unnecessary to perform processing to make the surface roughness extremely small. This processing has not therefore been positively applied.

However, according to the new discovery of the present inventors, to reduce the harmonic distortion, it is more important to control the surface roughness of the gap forming surface (RaG) than control the surface roughness of the reference surfaces (RaS). Therefore, according to the present invention, it is possible to reduce the harmonic distortion by making the surface roughness of the gap forming surface (RaG) within the above range.

The transformer core according to the present invention preferably has a surface roughness of the gap forming surface (RaG) forming the gap of RaG≧0.45 μm.

The transformer core according to the present invention more preferably has a surface roughness of the gap forming surface (RaG) forming the gap of RaG≧0.005 μm.

The transformer core according to the present invention preferably has a surface roughness of the reference surfaces (RaS) of 0.005 μm≦RaS≦1.0 μm.

In the present invention, by making the surface roughness of the gap forming surface (RaG) the above range and making the surface roughness of the reference surfaces (RaS) the above range, it is possible to further reduce the harmonic distortion.

The transformer core according to the present invention preferably has a relationship of the surface roughness of the gap forming surface (RaG) and the surface roughness of the reference surfaces (RaS) of RaG≦RaS.

According to the new discovery of the present inventors, reducing either of the gap forming surface and the reference surfaces in surface roughness enables the harmonic distortion to be reduced, but reducing the surface roughness of the gap forming surface (RaG) is more effective in reducing the harmonic distortion.

That is, when reducing the surface roughness of the gap forming surface (RaG) and the surface roughness of the reference surfaces (RaS) to similar levels, reducing the surface roughness of the gap forming surface (RaG) reduces the harmonic distortion more.

Therefore, to reduce the harmonic distortion, processing to reduce the surface roughness of the gap forming surface (RaG) is more effective than processing to reduce the surface roughness of the reference surfaces (RaS), so RaG≦RaS is preferable.

According to the present invention, by making the surface roughness of the gap forming surface (RaG) the above range, it is possible to reduce the harmonic distortion without having to reduce the surface roughness of the reference surfaces (RaS) to a high precision.

The transformer core according to the present invention preferably is comprised of Mn—Zn-based ferrite.

In the transformer core according to the present invention, preferably the Mn—Zn-based ferrite contains iron oxide converted to Fe₂O₃ in an amount of 51.0 to 55.0 mol %, manganese oxide converted to MnO in an amount of 20.0 to 30.0 mol %, and zinc oxide converted to ZnO in an amount of 18.0 to 25.0 mol %.

The transformer according to the present invention is fabricated by winding a coil around any of the above transformer cores.

Alternatively, the transformer according to the present invention has any of the above transformer cores and another transformer core combined with that transformer core and a coil wound around the combined transformer cores.

Note that the other transformer core may or may not also be a transformer core of the present invention. That is, it is sufficient that at least one of the combined transformer cores be a transformer core of the present invention.

The transformer according to the present invention is preferably a communications use transmission system transformer. As such a communications use transmission system transformer, for example, a transmission system transformer used in a modem for converting a digital signal and analog signal in xDSL technology, in particular a transmission system transformer used for an ADSL modem, may be mentioned.

The method of production of a transformer core according to the present invention comprises polishing the gap forming surface forming the gap by a grinding wheel having a particle size of the polishing abrasives of #400 to #8000 (JIS-R6001).

The method of production of a transformer core according to the present invention particularly uses as the grinding wheel one having a particle size of the polishing abrasives of #600 to #8000 (JIS-R6001).

According to the present invention, by making the surface roughness of the gap forming surface (RaG) forming the gap formed for the purpose of adjusting the inductance the above range, it is possible to produce a transformer core having a high inductance, a small inductance tolerance, and a small harmonic distortion, in particular total harmonic distortion (THD), and a transformer using the same.

Further, according to the method of production of the present invention, by making the particle size of the polishing abrasives of the grinding wheel used when polishing the gap forming surface forming the gap the predetermined range, it is possible to provide a method of production of a transformer core having a high inductance, a small inductance tolerance, and a small harmonic distortion, in particular total harmonic distortion (THD).

### BRIEF DESCRIPTION OF THE DRAWINGS

These and other objects and features of the present invention will become clearer from the following description of the preferred embodiments given with reference to the attached drawings, wherein:

FIGS. 1A and 1B are a perspective view and front view of an EP core having a gap forming surface according to a first embodiment of the present invention, while FIGS. 1C and 1D are a perspective view and front view of an EP core not having a gap forming surface;

FIGS. 2A and 2B are front views of the state before and after combining an EP core having a gap forming surface and an EP core not having a gap forming surface at their mating surfaces;

FIG. 3 is a view of an example of a method of processing a gap forming surface of a transformer core according to an embodiment of the present invention;

FIG. 4 is a view of another example of a method of processing a gap forming surface of a transformer core according to an embodiment of the present invention;

FIGS. 5A to 5E are views of examples of transformer cores according to embodiments of the present invention;

FIG. 6 is a view of an example of a method of processing reference surfaces and a gap forming surface of a transformer core according to an embodiment of the present invention;

FIG. 7 is a view of another example of a method of processing reference surfaces and a gap forming surface of a transformer core according to an embodiment of the present invention;

FIGS. 8A and 8B are views for explaining the dimensions of an EP core fabricated in examples of the present invention;

FIG. 9 is a circuit diagram of measurement of the THD in examples of the present invention;

FIG. 10 is a graph of the relationship between the surface roughnesses of the gap forming surface and reference surfaces and the THD in examples of the present invention; and

FIG. 11 is graph of the relationship of the surface roughnesses of reference surfaces and the THD in examples of the present invention.

### DESCRIPTION OF THE PREFERRED EMBODIMENTS

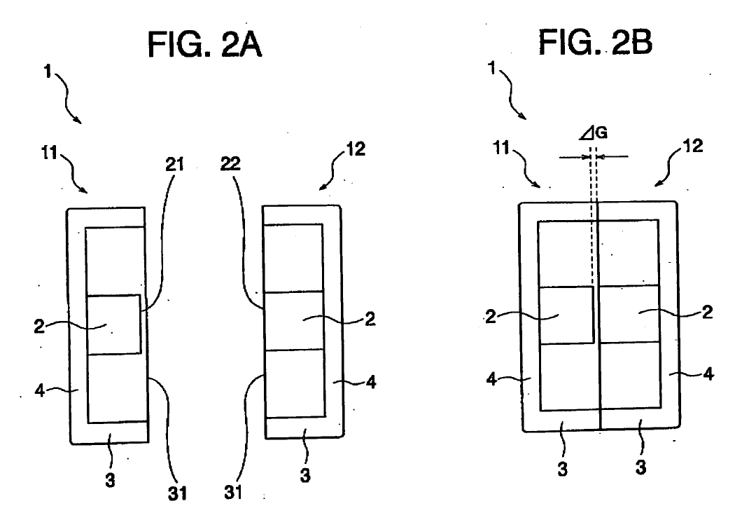

Preferred embodiments of the present invention will be described in detail below while referring to the attached figures. As shown in FIGS. 2A and 2B, a transformer core 1 according to an embodiment of the present invention is comprised of a combination of EP cores 11 and 12. The cores 11 and 12 are connected at their center legs 2 and outer legs 3.

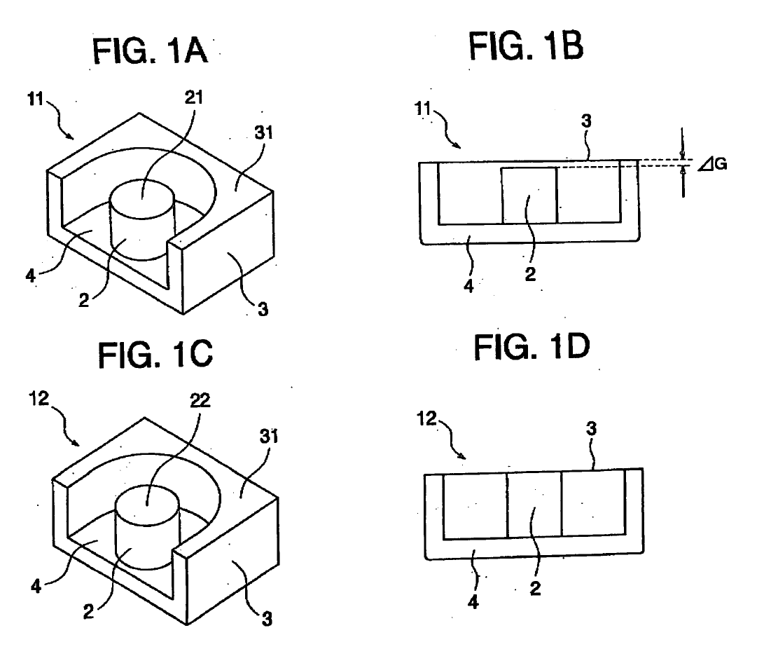

The EP core 11 having the gap forming surface shown in FIGS. 1A and 1B has a gap forming surface 21 on the top surface of its center leg 2 and has reference surfaces 31 on the top surfaces of its outer legs 3. This EP core 11 has a gap ΔG of the difference in heights from the bottom 4 of the gap forming surface 21 and the reference surfaces 31.

The EP core 12 not having a gap forming surface shown in FIGS. 1C and 1D has a reference surface 22 on the top surface of its center leg 2 and has reference surfaces 31 on the top surfaces of its outer legs 3 as well. These are substantially on the same plane, so there is no gap ΔG.

The transformer core 1 according to this embodiment, as shown in FIGS. 2A and 2B, is comprised of the EP core 11 having the gap forming surface and the EP core 12 not having the gap forming surface combined so that the reference surfaces 31 of the outer legs 3 are superposed and is used as a paired transformer core 1. This combined transformer core 1 is formed with a gap ΔG between the gap forming surface 21 of the EP core 11 having a gap forming surface and the reference surfaces 22 of the EP core 12 not having a gap forming surface. The transformer according to this embodiment therefore has a gap ΔG for adjusting the inductance. By adjusting the depth of this gap ΔG, it becomes possible to adjust the inductance.

Transformer Core

The transformer core 1 (cores 11 and 12) of this embodiment is comprised of an Mn—Zn-based ferrite composition containing iron oxide, manganese oxide, and zinc oxide.

The range of the content of the iron oxide is, converted to Fe₂O₃, preferably 51.0 to 55.0 mol %, more preferably 52.0 to 54.0 mol %.

If the content of iron oxide is too small, the crystal magnetic anisotropy in the core will become great and the harmonic distortion will tend to increase. Similarly, even if too great, the harmonic distortion will tend to increase.

The range of the content of the manganese oxide is, converted to MnO, preferably 20.0 to 30.0 mol %, more preferably 21.0 to 29.0 molt.

If the content of the manganese oxide is too small, the Curie point will fall to the region of the actual usage temperature and the properties as ferrite will tend to be lost, while if too great, the crystal magnetic anisotropy in the core will become great and the harmonic distortion will increase.

The range of the content of the zinc oxide is, converted to ZnO, preferably 18.0 to 25.0 mol %, more preferably 21.0 to 25.0 mol %.

If the content of the zinc oxide is too small, the crystal magnetic anisotropy in the core will become great and the harmonic distortion will become increase, while if too great, the Curie point will fall to the region of the actual usage temperature and the properties as ferrite will be lost.

Further, various additives may be included other than the above iron oxide, zinc oxide, and manganese oxide in a range where the objects of the present invention can be achieved.

Next, the method of production of the transformer core 1 (cores 11 and 12) of this embodiment will be explained. First, as the starting materials, Fe₂O₃, MnO, ZnO, or materials giving these oxides after firing and in accordance with need other materials are prepared.

The prepared starting materials are weighed and adjusted to give the target composition in the final composition after firing.

Note that the mixture of the materials may contain unavoidable impurity elements in the materials. As such elements, B, Al, Si, P, Ca, Cr, Co, Na, K, S, Cl, etc. may be mentioned. To suppress the power lose or effects on the magnetic characteristics, it is preferable that the weight ratio of these elements to the entire composition be not more than 500 ppm. Particularly, for B and P, it is preferably not more than 100 ppm.

The weighed starting materials are mixed and then calcined. The calcining is for causing thermal decomposition of the materials, equalization of the ingredients, formation of ferrite, elimination of superfine particles by wintering, and growth to a suitable particle size and for converting the mixture of materials to a form suitable for later steps. The calcination is performed in an oxidizing atmosphere, usually in the air. The calcination temperature is preferably 800 to 1000° C.

Next, the obtained-calcined material is pulverized to obtain pulverized material. This pulverization is performed to break up masses of the calcined material and produce a powder having suitable sinterability. When the calcined material forms large lumps, it is roughly pulverized, then wet pulverized using a ball mill, atrighter, etc.

Next, the pulverized material is granulated to obtain a granulate. The granulation is performed to make the pulverized material a suitable size of agglomerated particles and convert it to a form suitable for shaping. As the granulation method, for example, press granulation, the spray dry method, etc. may be mentioned. The spray dry method is the method of adding to the pulverized material polyvinyl alcohol or another conventionally used binder, then atomizing and drying the mixture in a spray dryer.

Next, the granulate is formed into a predetermined shape to obtain a shaped article. As the method for shaping the granulate, for example, dry shaping, wet shaping, extrusion, etc. may be mentioned. Dry shaping is the method of packing the granulate into a mold, then pressing it.

The shape of the shaped article is not particularly limited and may be suitably determined in accordance with the application, but in this embodiment, it is an EP core as shown in FIGS. 1A to 1D.

In this embodiment, first, a plurality of EP cores 12 shown in FIGS. 1C and 1D having the same heights of the reference surfaces 22 of the center legs 2 and reference surfaces 31 of the outer legs 3, that is, not having gap forming surfaces, are shaped and fired to obtain sintered bodies of EP cores 12 not having gap forming surface.

This firing is performed for causing sintering of the powder at a temperature below the melting point in the powder particles of the shaped articles including large numbers of pores so as to obtain dense sintered bodies. The cores are raised in temperature at a rate of 50 to 300° C./hr and held at a stable temperature of 1200 to 1400° C. for 2 to 8 hours. In the cooling zone from the stable temperature, they are preferably held in an atmosphere controlled to the equilibrium oxygen partial pressure of Mn—Zn-based ferrite.

Next, the surfaces of the sintered bodies are ground. First, the surfaces are ground to adjust the surface roughnesses of the reference surfaces (RaS) for the reference surfaces 22 of the center legs 2 and the reference surfaces 31 of the outer legs 3 of the sintered bodies of the EP cores 12 not having gap forming surfaces.

The method for grinding the surfaces for adjusting the surface roughnesses of the reference surfaces (RaS) is not particularly limited and may be any processing method enabling control of the surface roughness or flatness of reference surfaces. For example, a processing method using a vertical processing machine may be mentioned.

The surface roughness of the reference surfaces (RaS) is preferably 0.005 μm≦RaS≦1.0 μm, more preferably 0.005 μm≦RaS≦0.70 μm, still more preferably 0.005 μm≦RaS≦0.20 μm.

If the surface roughness of the reference surfaces (RaS) is too large, leakage of the flux will occur and the hysteresis loss will become large, so the harmonic distortion will tend to become large. Further, making the surface roughness of the reference surfaces (RaS) an extremely small value (for example, RaS=0.005 μm or less) is difficult since there are pores between crystal particles or in Crystal particles in a polycrystal such as ferrite and since the processing cost becomes high. Note that in this embodiment, it is particularly preferred to mirror polish or otherwise finely process the reference surfaces serving as the mating surfaces to make the surface roughness of the reference surfaces (RaS) 0.005 to 0.20 μm.

Note that here, the “surface roughness” means the surface roughness based on JIS-B0601 (arithmetic surface height: Ra). Further, the surface roughness may be measured by for example using a surface roughness meter etc.

Next, to obtain EP cores 11 having gap forming surfaces shown in FIGS. 1A and 1B, the EP cores 12 ground at their surfaces above and not having gap forming surfaces are ground at their surfaces for the purpose of forming gaps at the top surfaces of the center legs 2 so as to thereby form the gap forming surfaces 21 at the top surfaces of the center legs 2.

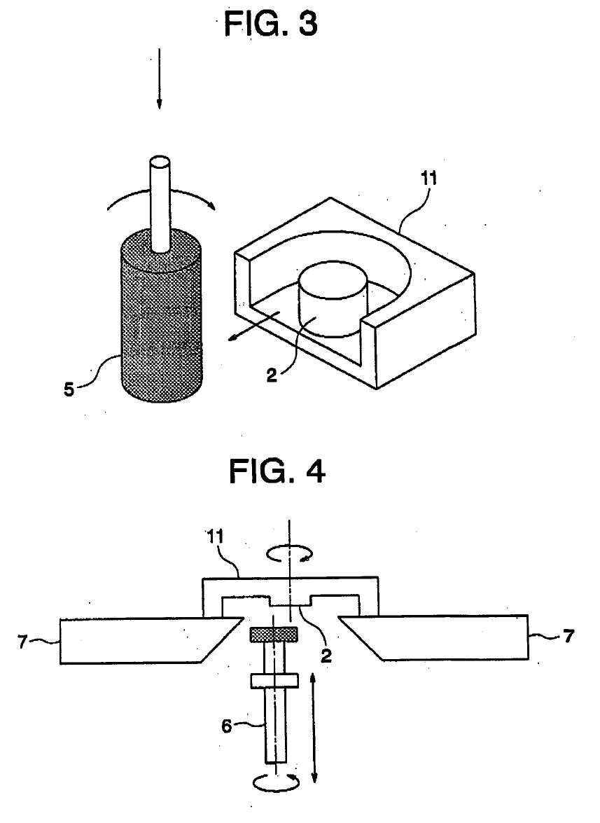

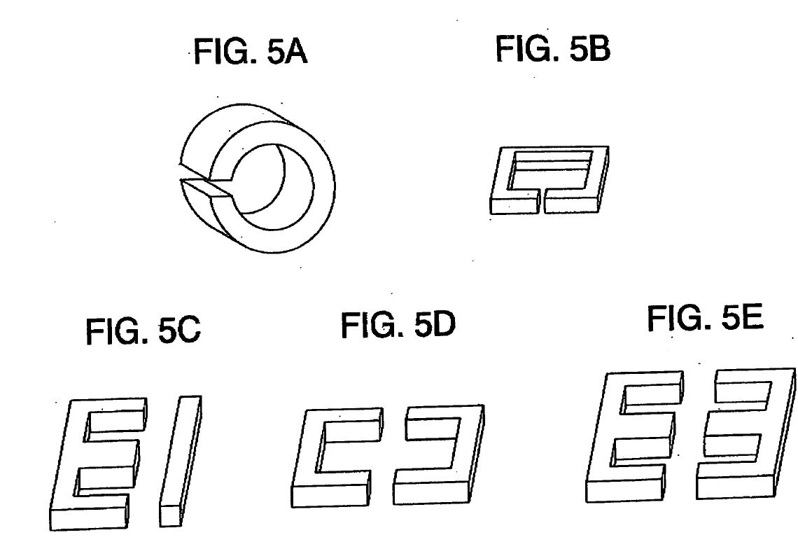

The method for surface grinding for forming the gaps is not particularly limited and may be suitably selected in accordance with the shape of the transformer cores but for example a split core like the EP core of the present embodiment may be ground by the method such as shown in FIG. 3 or FIG. 4.

In the processing method shown in FIG. 3, a columnar grinding wheel 5 having polishing abrasive surfaces at its bottom and side surfaces is rotated, lowered to the depth of the gap, and moved back and forth along the center leg 2 of the EP core 11 so as to form the gap forming surface 21.

Further, in the processing method shown in FIG. 4, by fixing the EP core 11 on the grinding table 7 with the top surface of its center leg 2 facing downward, rotating the grinding wheel 6 having the polishing abrasive surface at its top surface and the EP core 11, and lowering the grinding wheel 6, the top surface of the center leg 2 is ground to form the gap forming surface 21. Note that the EP core 11 may also be made to rotate by turning the grinding table 7.

In this embodiment, the surface roughness of the gap forming surface 21 (RaG) formed by the processing is RaG≦0.70 μm, preferably RaG≦0.45 μm, more preferably RaG≦0.30 μm. Further, the lower limit of the surface roughness is preferably RaG≧0.005 μm or so.

The characterizing point of the present invention is that the surface roughness of the gap forming surface 21 (RaG) is made the above range. By doing this, it becomes possible to obtain a transformer core having a high inductance, a small inductance tolerance, and a small harmonic distortion.

Note that the correlation between the surface roughness of the gap forming surface 21 (RaG) and the harmonic distortion is not necessarily clear, but it may be that if the surface roughness of the gap forming surface (RaG) is large, the variation in the flux density at the gap forming surface becomes large, leakage of flux becomes large, hysteresis loss in the AC magnetic field increases, and as a result the harmonic distortion increases.

If the surface roughness of the gap forming surface (RaG) is too great, due to the above facts, the harmonic distortion tends to increase. Further, making the surface roughness of the gap forming surface (RaG) an extremely small value (for example, RaG=0.005 μm or less) is difficult since there are pores between crystal particles or in crystal particles in a polycrystal such as ferrite and since the processing cost becomes high.

Further, as explained above, it is important to control, as the factors increasing the harmonic distortion, not only the surface roughness of the gap forming surface (RaG), but also the surface roughness of the reference surfaces 31 (mating surfaces). (RaS). Therefore, it is preferable to make the surface roughness of the gap forming surface (RaG) the above range and further to make the surface roughness of the reference surfaces (RaS) the above range. By doing this, it becomes possible to reduce the harmonic distortion compared with the past.

In this embodiment, the, relationship between the surface roughness of the gap forming surface (RaG) and the surface roughness of the reference surfaces (RaS) is made RaG≦RaS. This is because to reduce the harmonic distortion, processing the surface roughness of the gap forming surface (RaG) is more effective than, processing the surface roughness of the reference surfaces (RaS).

The grinding wheel used when grinding the surface for forming the gap preferably has a particle size of the polishing abrasives forming the grinding wheel of #400 to #8000 (JIS-R6001), more preferably #600 to #8000.

If the particle size of the polishing, abrasive is larger than #400, the surface roughness of the gap forming surface (RaG) tends not to be able to be made sufficiently small. Further, if the particle size is smaller than #8000, the processing cost tends to increase.

Transformer

The transformer according to thia embodiment, as shown in FIG. 2, is comprised of an EP core 11 having a gap forming surface and an EP core 12 not having a gap forming surface combined so that the reference surfaces 31 of the outer legs 3 are superposed over each other so as to form a paired transformer core and around the center leg 2 of which a winding is wound a predetermined number of turns.

The transformer according to the present embodiment can be adjusted in inductance by adjusting the depth of the gap ΔG formed between the gap forming surface 21 of the EP core 11 having the gap forming surface and the reference surfaces 22 of the EP core 12 not having the gap forming surface.

Note that the present invention is not limited to the above embodiment and may be modified in various ways within the scope of the present invention.

For example, in the above embodiment, the relationship between the surface roughness of the gap forming surface (RaG) and the surface roughness of the reference surfaces (RaS) was made RaG≦RaS, but it is also possible to make it a range where the relationship of RaG≦RaS does not stand so long as the objects of the present invention can be achieved. That is, in the above embodiment, the relationship was made RaG≦RaS so as to efficiently reduce the harmonic distortion, but if considering the difficulty of the production process, it is also possible to make RaG≧RaS.

Further, in the above embodiment, an EP transformer core was illustrated, but the transformer core according to the present invention may also be made a core of the different shapes shown in FIGS. 5A to 5E.

FIG. 5A shows a nonsplit core where part of the core is cleaved by a fine cutter or surfacer etc. to form a gap resulting in a toroidal core having a gap ΔG.

FIG. 5B also shows a nonsplit core where part of the core is similarly cleaved by a fine cutter or surfacer etc. to form a gap resulting in an FT core having a gap ΔG.

FIG. 5C shows a split core comprised of an E-core and I-core combined to form an EI core. In this core, for example, the center leg of the E-core is processed to form a gap forming surface. Further, the E-core having this gap forming surface and the I-core are combined to form the gap ΔG.

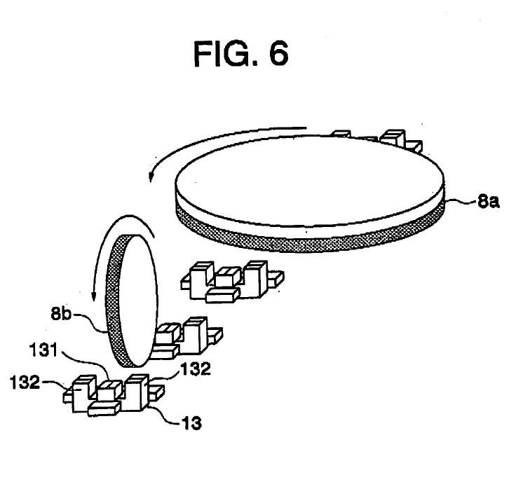

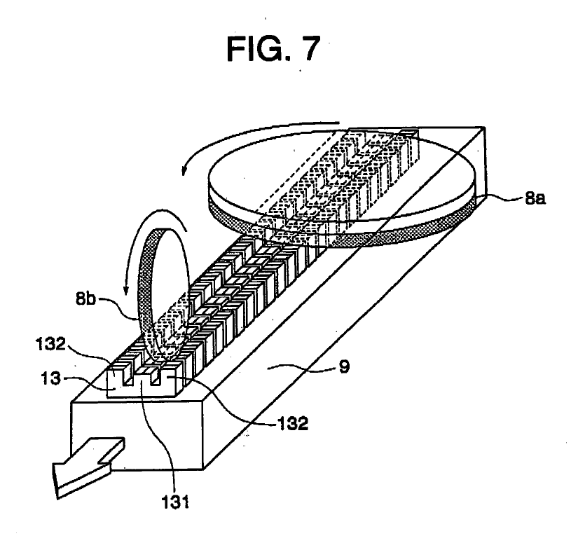

Note that when processing the E-core to form the gap, as the processing method, for example, the method shown in FIG. 6 or FIG. 7 may be used.

FIG. 6 shows a method for continuously processing the mating surfaces and the gap forming surface. In this method, for example, first, by bringing the top surfaces of the outer legs 132 and center leg 131 of the E-core 13 and the bottom surface of the disk-shaped grinding wheel 8a having polishing abrasive surfaces at its bottom surface and side surface into contact and rotating the disk-shaped grinding wheel 8a, the top surfaces of the outer legs 132 and the center leg 131 are ground. Next, by bringing the top surface of the center leg 131 of the E-core 13 and the side face of the columnar grinding wheel 8b having the polishing abrasive surface at its side surface into contact and rotating the columnar grinding wheel 8b, the top surface of the center leg 131 is ground to form the gap forming surface. Note that in the processing method shown in FIG. 6, the grinding is performed in the state with the E-core fixed. Further, the axis of rotation of the grinding wheel 8a and the axis of rotation of the grinding wheel 8b are perpendicular in relation.

The processing method shown in FIG. 7, like the processing method shown in FIG. 6, continuously processes the mating surfaces and the gap forming surface. Unlike the processing method shown in FIG. 6, however, it fixes the E-core on a magnetic chuck 9 and has the magnetic chuck 9 move for the continuously grinding. Note that the processing methods shown in FIGS. 6 and 7 are both methods continuously processing the mating surfaces and gap forming surface, but the mating surfaces may also be ground separately from the gap forming surface. That is, in FIGS. 6 and 7, it is also possible that the processing method not use the grinding wheel 8a or that the processing method not use the grinding wheel 8b.

FIG. 5D also shows a split core. This is comprised of two U-cores combined to form a UU core. In this core, for example, the side surfaces of the two legs of the two U-cores are made the gap forming surfaces. Dielectric films are sandwiched between the lap forming surfaces of the two cores to form the gap ΔG.

FIG. 5E also shows a split core with two E-cores combined to form an EE core. In this core, for example, the center leg in one of the two E-cores is processed to form the gap forming surface. The E-core having this gap forming surface and the E-core not having this gap forming surface are combined to form a gap ΔG. Further, cores having gap forming surface may also be combined.

### EXAMPLES

Below, the present invention will be explained in further detail by examples, but the present invention is not limited to these examples.

### Example 1

Fabrication of Core

The starting materials of the main ingredient and the secondary ingredient were prepared. As the starting materials of the main ingredient, Fe₂O₃, MnO, and ZnO were used, Further, as the starting materials of the secondary ingredient, SiO₂ and CaO were used. These starting materials were weighed to give the following composition after firing:
Fe₂O₃: 53 mol %
MnO: 24 mol %
ZnO: 23 mol %
SiO₂: 0.01 wt %
CaO: 0.06 wt %

Note that the amounts of Fe₂O₃, MnO, and ZnO were expressed as molt with respect to the entire main ingredient, while the amounts of SiO₂ and CaO added were expressed as wt % with respect to the ferrite composition as a whole.

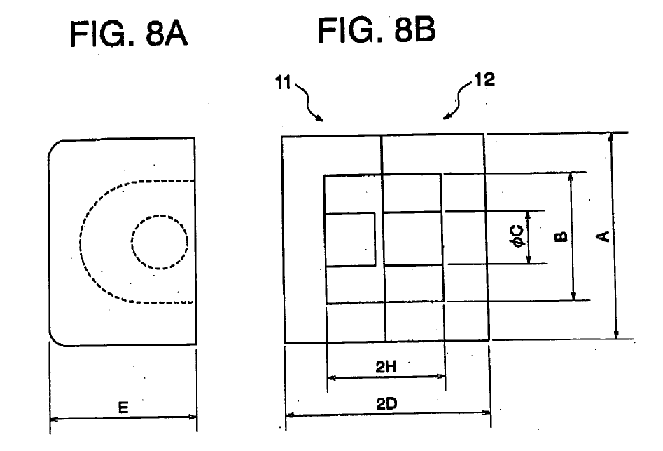

Next, these materials were mixed, calcined, and pulverized under the following conditions to prepare the ferrite material:
Mixing and pulverizing pot: Stainless steel ball mill pot used
Mixing and pulverizing medium: Steel balls used
Mixing time: 16 hours
Calcination conditions: 850° C., 3 hours
Pulverization time after calcining: 8 hours
   1.0 part by weight of polyvinyl alcohol was added as a binder to 100 parts by weight of the obtained ferrite material. The mixture was granulated to prepare granules which were then press formed and fired at 1350° C. so as to obtain EP cores (EP 13) having center legs and outer legs. Note that the dimensions of the EP cores were, in FIG. 8, made A=12.5±0.3 mm, B=10.0±0.3 mm, φC=4.35±0.15 mm, 2D=12.85±0.15 mm, E=8.8±0.2 mm, and 2H=9.2±0.2 mm.

Next, the center legs and the outer legs of the sintered bodies obtained by the above were processed at their surfaces by a vertical processing machine to obtain EP cores not having gap forming surfaces. The surface roughnesses of the reference surfaces (RaS) of the center legs and the outer legs were 0.100 μm. Note that for measurement of the surface roughnesses, a Surfcorder SE-30D made by Kosaka Laboratory Ltd. was used.

Further, half of the samples of the EP cores not having gap forming surfaces were processed at the reference surfaces of the center legs by MGL (minigap line) processing to obtain EP cores having gap forming surfaces. Here, by adjusting the particle size of the polishing abrasives of the grinding wheel when MGL processing the samples and the grinding rate and other processing conditions, Samples 1 to 16 having the different surface roughnesses of the gap forming surfaces (RaG) shown in Table 1 were fabricated. Note that the gap depths at this time were adjusted to give inductances of 5.0 mH and inductance tolerances of ±9%. As a result, the gap depths were about 30 μm. The inductances were measured by fabricating 100 turn coils and using an LCR meter (made by Hewlett Packard Inc.) at a measurement frequency of 1 kHz and a measurement current of 0.5 mA.

Fabrication of Transformer

Similarly, an EP core not having a gap forming surface and an EP core having a gap forming surface were arranged with the contact surfaces 31 of the outer legs 3 superposed as shown in FIG. 2 and the center legs 2 of the two cores-were inserted into a bobbin around which the primary winding and secondary winding were wound so as to fabricate a transformer sample.

Note that to make the linkage inductance smaller, the primary winding is divided into two and the winding made a sandwich winding of a primary winding (70 turns)—secondary winding (140 turns)—primary winding (70 turns).

Measurement of Total Harmonic Distortion (THD)

Each transformer sample fabricated above was connected to an audio analyzer (System 2 made by Precision Co.) and measured for THD. In this example, when evaluating the harmonic distortion of the transformer sample, the total harmonic distortion (THD) was measured and evaluated. Note that the total harmonic distortion (THD) is calculated by the following equation:
THD(dB)=20×log[(harmonic+noise)/(basic wave+harmonic+noise) (1)

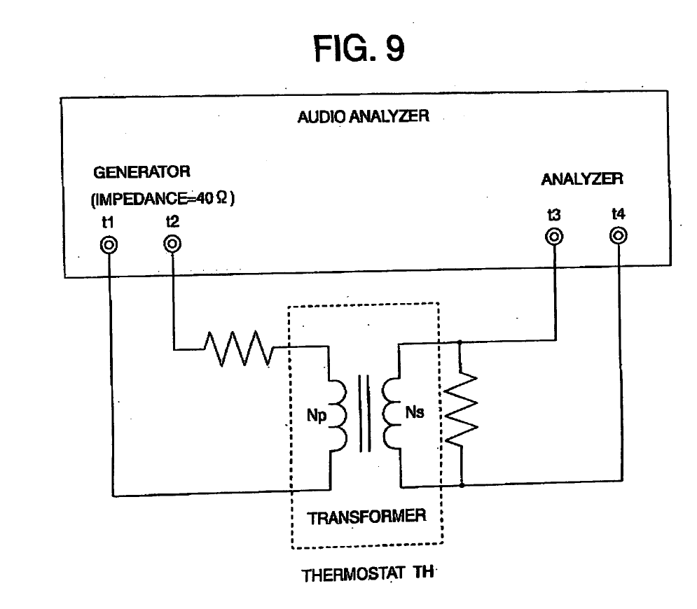

As shown in FIG. 9, the primary winding Np was connected in series to a 10 Ω resistance and was connected to the generator side terminals t1 and t2, while the secondary winding Ns was connected in parallel to a 50 Ω resistance and connected to the analyzer side terminals t3 and t4. Note that the generator side of the measuring device had a 40 Ω resistance connected in series to it, so the primary winding had a total of 50 Ω resistance connected in series to it.

The measurement was performed by inputting to the primary winding Np of the transformer a 5 kHz frequency data signal so as to give a voltage at the two ends of the primary winding of 2.5V and, at this time, inputting from the terminals t3 and t4 and analyzing a transmission waveform output from the primary winding Hp side to the secondary winding Ns side. At this time, as shown in FIG. 9, the transformer was placed in a thermostat TX, held at 25° C., and measured. A smaller value of the THD is preferred.

Note that in general if measuring the TED at a high frequency, the value of the THD becomes smaller and a good result can be obtained more easily, so no significant difference easily appears in the THD properties of transformers. Therefore, to get a significant difference to appear in the THD properties of transformers, it is necessary to measure the THD at a low frequency. In this example, the THD was measured at 5 kHz.

TABLE 1

| Sample | | RaG | RaS | THD |
|---|---|---|---|---|
| No. | | (μm) | (μm) | (dB) |
| 1 | Ex. | 0.085 | 0.100 | −92.1 |
| 2 | Ex. | 0.150 | 0.100 | −91.5 |
| 3 | Ex. | 0.240 | 0.100 | −91.4 |
| 4 | Ex. | 0.310 | 0.100 | −90.1 |
| 5 | Ex. | 0.440 | 0.100 | −90.2 |
| 6 | Ex. | 0.480 | 0.100 | −89.9 |
| 7 | Ex. | 0.570 | 0.100 | −89.4 |
| 8 | Ex. | 0.590 | 0.100 | −89.1 |
| 9 | Ex. | 0.810 | 0.100 | −89.3 |
| 10 | Ex. | 0.650 | 0.100 | −88.8 |
| 11 | Ex. | 0.690 | 0.100 | −88.9 |
| 12 | Comp. Ex. | 0.850 | 0.100 | −87.5 |
| 13 | Comp. Ex. | 0.940 | 0.100 | −86.7 |
| 14 | Comp. Ex. | 0.960 | 0.100 | −87.1 |
| 15 | Comp. Ex. | 1.150 | 0.100 | −86.5 |
| 16 | Comp. Ex. | 1.230 | 0.100 | −85.7 |

Table 1 shows the surface roughness of the gap forming surface (RaG), surface roughness of the reference surfaces (RaS), and results of measurement of the THD for Samples 1 to 16 of transformers with EP cores having different surface roughnesses of the gap forming surfaces (RaG). Note that all of the samples had surface roughnesses of the reference surfaces (RaS) of 0.100 μm.

In this example, the surface roughnesses of the reference surfaces (in FIG. 1, the reference surface 31 of the outer leg 3 of the EP core 11 having a gap forming surface, the reference surface 22 of the center leg 2 of the EP core 12 not having a gap forming surface, and the reference surface 31 of the outer leg 3, i.e., a total of three surfaces) (RaS) were made the same.

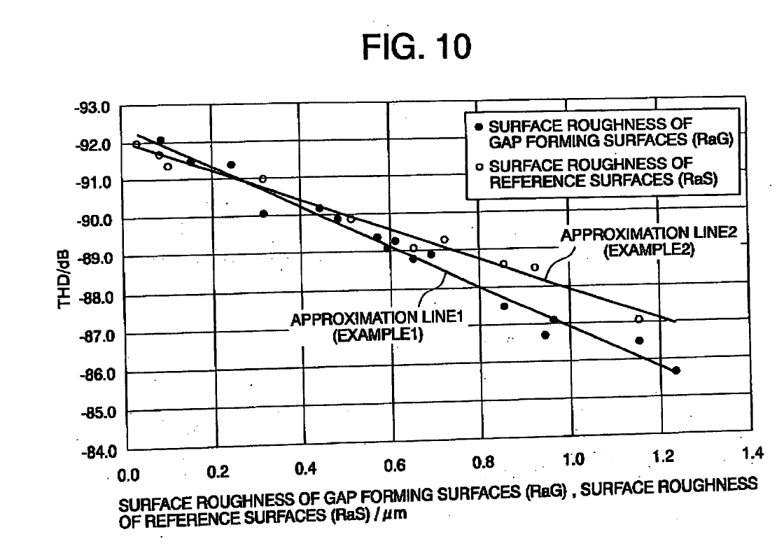

From Table 1, it can be confirmed that when the surface roughness of the reference surfaces (RaS) is constant, the smaller the surface roughness of the gap forming surface (RaG), the smaller the value of THD becomes. Further, this trend is clear from FIG. 10 showing by a graph the surface roughness of the gap forming surface (RaG) and the results of measurement of the THD (the results of this example being shown by the blacked dots in FIG. 10). Further, Samples 1 to 11 having surface roughnesses of the gap forming surfaces (RaG) of 0.100 μm or less all had THD values of −88.5 dB or less or all good values.

### Example 2

Except for processing the reference surfaces and processing the gap forming surfaces under the following conditions when fabricating EP cores not having gap forming surfaces and EP cores having gap forming surfaces, cores were fabricated under conditions similar to Example 1. The cores were used to fabricate transformer samples which were then measured for THD.

The reference surfaces were processed by a vertical processing machine in the same way as Example 1, but in this example the processing conditions were changed to fabricate EP cores having different surface roughnesses of the reference surfaces (RaS) and not having gap forming surfaces.

Further, to obtain EP cores having gap forming surfaces, the EP cores not having gap forming surfaces fabricated above were processed to form gap forming surfaces. The gap forming surfaces were processed to give surface roughnessess of the gap forming surfaces (RaG) of a constant 0.240 μm.

That is, in this example, cores having constant surface roughnesses of the gap forming surfaces (RaG) and different surface roughnesses of the reference surfaces (RaS) were fabricated and evaluated for properties. Further, in this example as well, like in Example 1, the surface roughnesses of the reference surfaces (total of three surfaces). (RaS) of the cores forming the transformer samples were made the same.

TABLE 2

| Sample | | RaG | RaS | THD |
|---|---|---|---|---|
| No. | | (μm) | (μm) | (dB) |
| 17 | Ex. | 0.240 | 0.030 | −92.0 |
| 18 | Ex. | 0.240 | 0.080 | −91.7 |
| 3 | Ex. | 0.240 | 0.100 | −91.4 |
| 19 | Ex. | 0.240 | 0.310 | −91.0 |
| 20 | Ex. | 0.240 | 0.510 | −89.9 |
| 21 | Ex. | 0.240 | 0.650 | −89.1 |
| 22 | Ex. | 0.240 | 0.720 | −89.3 |
| 23 | Ex. | 0.240 | 0.850 | −88.6 |
| 24 | Ex. | 0.240 | 0.920 | −88.5 |
| 25 | Ref. Ex. | 0.240 | 1.150 | −87.1 |

Table 2 shows the surface roughness of the gap forming surface (RaG), surface roughness of the reference surfaces (RaS), and results of measurement of the THD for Samples 3 and 17 to 25 with different surface roughnesses of the reference surfaces (RaS). Note that all of the samples shown in Table 2 are samples with surface roughnesses of the gap forming surfaces (RaG) of 0.240 μm.

From Table 2, it can be confirmed that when the surface roughness of the gap forming surface (RaG) is constant, if making the surface roughness of the reference surfaces (RaS) smaller, the value of THD becomes smaller. Further, this trend is clear from FIG. 10 showing by a graph the relationship between the surface roughness of the reference surfaces (RaS) and the values of the THD (the results of this example being shown by the white dots in FIG. 10). Further, Samples 3 and 17 to 24 with surface roughnesses of the reference surfaces (RaS) of 1.000 μm or less all had values of THD of −88.5 dB or less or good results.

Note that from FIG. 10, it can be confirmed that the approximation line 1 in the case of changing the surface roughness of the gap forming-surface (RaG) (black dots) has a larger inclination than the approximation line 2 of the case of changing the surface roughness of the reference surfaces (RaS) (white dots). That is, it could be confirmed that the effect of improvement of the THD is larger in the case of changing the surface roughness of the gap forming surface (RaG) than the case of changing the surface roughness of the reference surfaces (RaS). Therefore, in this example, good results are obtained even in Samples 2 to 11 with RaG>RaS. Even when making RaG>RaS, the objects of the present invention can be achieved. If considering the above results, however, it is more preferable that RaG≦RaS.

Note that the reasons for this are not necessarily clear, but it may be that in an EP core, the magnetic flux concentrates at the center leg where the gap is formed rather than the outer legs having mating surfaces.

### Example 3

Except for making the surface roughnesses of the gap forming surfaces (RaG) 0.500 μm, cores were fabricated in the same way as Example 2. The cores were used to fabricate transformer samples which were then measured for THD. In this example as well, like in Examples 1 and 2, the surface roughnesses of the reference surfaces (total three surfaces) (RaS) of the cores forming the transformers were made the same.

TABLE 3

| Sample | | RaG | RaS | THD |
|---|---|---|---|---|
| No. | | (μm) | (μm) | (dB) |
| 3 | Ex. | 0.240 | 0.100 | −91.4 |
| 26 | Ex. | 0.500 | 0.100 | −89.8 |
| 21 | Ex. | 0.240 | 0.650 | −89.1 |
| 27 | Ex. | 0.500 | 0.650 | −87.8 |
| 25 | Ref. Ex. | 0.240 | 1.150 | −87.1 |
| 28 | Ref. Ex. | 0.500 | 1.150 | −85.6 |

Table 3 shows the surface roughness of the gap forming surface (RaG), surface roughness of the reference surfaces (RaS), and the results of measurement of the THD for Samples 3, 21, and 25 to 28 of transformers with surface roughness of the gap forming surfaces (RaG) of 0.240 or 0.500 μm and different surface roughnesses of the reference surfaces (RaS).

From Table 3, it was learned that between Samples 3 and 26 having the same surface roughnesses of the reference surfaces (RaS) of 0.100 μm and having different surface roughness of the gap forming surfaces (RaG), Sample 3 with the smaller surface roughness of the gap forming surface (RaG) has a small value of THD. Similar results were obtained in Samples 21 and 27 and in Samples 25 and 28 as well.

Further, Sample 21 had a surface roughness of the gap forming surface (RaG) of 0.240 μm, so despite the surface roughness of the reference surfaces (RaS) being 0.650 μm, it was possible to obtain a THD of the same extent as Sample 26 with the surface roughness of the reference surfaces (RaS) of 0.100.

That is, it was confirmed that by making the surface roughness of the gap forming surface (RaG) smaller, it was possible to obtain a THD of the same extent as the case of making the surface roughness of the reference surfaces (RaS) a high precision (for example, RaS=0.100 or less) without making it a high precision. Further, a similar trend was observed in Samples 25 and 27.

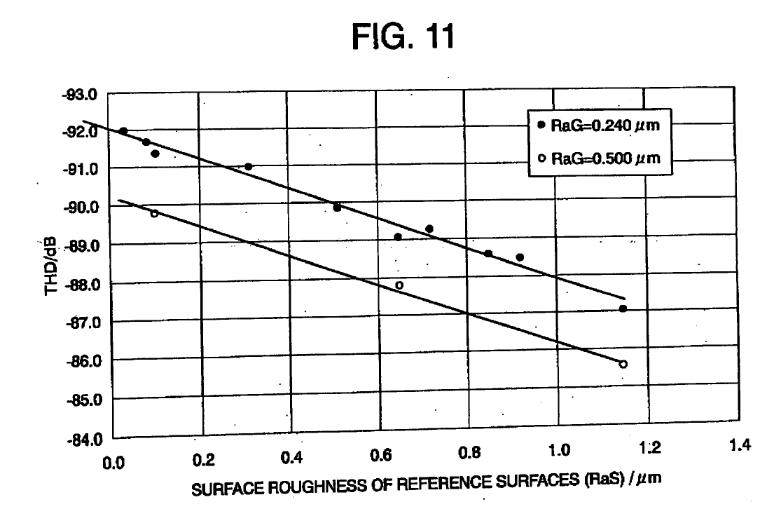

Further, this trend is clear from FIG. 11 showing by a graph the relationship between a sample with a surface roughness of the gap forming surface (RaG) of 0.240 μm and the surface roughness of the reference surfaces (RaS) of a sample with an RaG of 0.500 μm and THD. That is, from FIG. 11, it is learned that for example when desiring to make the value of THD −90 or less, if RaG is 0.500 μm, it is necessary to make RaS 0.1 μm or so, while if RaG is 0.240 μm, this can be sufficiently achieved even with an RaS of 0.5 μm or so.

### Example 4

Except for processing the gap forming surface under the following conditions when fabricating the EP core having a gap forming surface, cores were fabricated under conditions similar to Example 1. The cores were used to fabricate transformer samples which were then measured for THD.

The gap forming surfaces were processed by MGL processing in the same way as Example 1. The particle sizes of the polishing abrasives of the grinding wheels used in the MGL processing were changed to #200, #300, #400, #600, and #800. The rest of the processing conditions were made constant. Note that the surface roughness of the reference surfaces (RaS) was made 0.100 μm. In this example as well, like in Example 1, the surface roughnesses of the reference surfaces (total three surfaces) (RaS) of the cores forming the transformers were made the same.

TABLE 4

| Sample | | Particle Size of | RaG | RaS | THD |
|---|---|---|---|---|---|
| No. | | Grinding Wheels | (μm) | (μm) | (dB) |
| 29 | Ex. | #800 | 0.290 | 0.100 | −91.5 |
| 30 | Ex. | #600 | 0.480 | 0.100 | −90.1 |
| 31 | Ex. | #400 | 0.610 | 0.100 | −89.1 |
| 32 | Ref. Ex. | #300 | 0.710 | 0.100 | −88.0 |
| 33 | Ref. Ex. | #200 | 0.850 | 0.100 | −87.9 |

Table 4 shows the particle size of the grinding wheels of Samples 29 to 33 changed in particle size of the polishing abrasive, the surface roughness of the gap forming surface (RaG), the surface roughness of the reference surfaces (RaS), and the results of measurement of the THD.

From Table 4, it can be formed that if making the particle of the grinding wheel used finer, the surface roughness of the gap forming surface (RaG) becomes smaller and the THD also becomes smaller. In particular, the samples having particle sizes of #400, #600, and #800 had surface roughness of the gap forming surfaces (RaG) of not more than 0.70 and THD of not more than −8.5 dB—all good results.

While the invention has been described with reference to specific embodiments chosen for purpose of illustration, it should be apparent that numerous modifications could be made thereto by those skilled in the art without departing from the basic concept and scope of the invention.

1. A transformer core having a gap for adjustment of the inductance, wherein the surface roughness of the gap forming surface (RaG) forming the gap is RaG≦0.70 μm.

2. A split transformer core having reference surfaces and a gap forming surface and having a gap of the difference in height between said reference surfaces and said gap forming surface, wherein the surface roughness of the gap forming surface (RaG) forming the gap is RaG≦0.70 μm.

3. The transformer core as set forth in claim 1, wherein the surface roughness of the gap forming surface (RaG) forming the gap is RaG≦0.45 μm.

4. The transformer core as set forth in claim 1, wherein the surface roughness of the gap forming surface (RaG) forming the gap is RaG≧0.005 μm.

5. The transformer core as set forth in claim 2, wherein the surface roughness of the gap forming surface (RaG) forming the gap is RaG≦0.45 μm.

6. The transformer core as set forth in claim 2, wherein the surface roughness of the gap forming surface (RaG) forming the gap is RaG≧0.005 μm.

7. The transformer core as set forth in claim 2, wherein the surface roughness of the reference surfaces (RaS) is 0.005 μm≦RaS≦1.0 μm.

8. The transformer core as set forth in claim 2, wherein the relationship of the surface roughness of the gap forming surface (RaG) and the surface roughnesses of the reference surfaces (RaS) is RaG≦RaS.

9. The transformer core as set forth in claim 1, wherein said transformer core is comprised of Mn—Zn-based ferrite.

10. The transformer core as set forth in claim 9, wherein the Mn—Zn-based ferrite contains iron oxide converted to Fe₂O₃ in an amount of 51.0 to 55.0 mol %, manganese oxide converted to MnO in an amount of 20.0 to 30.0 mol %, and zinc oxide converted to ZnO in an amount of 18.0 to 25.0 mol %.

11. A transformer comprised of a transformer core as set forth in claim 1 around which a coil is wound.

12. A transformer comprised of a transformer core as set forth in claim 1 and another transformer core combined with that transformer core and a coil wound around the combined transformer cores.

13. The transformer as set forth in claim, 11, wherein said transformer is a communications use transmission system trans former.

14. A method of production of a transformer core as set forth in claim 1 comprising polishing the gap forming surface forming the gap by a grinding wheel having a particle size of the polishing abrasives of #400 to #8000 (JIS-R6001).

15. The method of production of a transformer core as set forth in claim 14, further comprising using as the grinding wheel one having a particle size of the polishing abrasives of #600 to #8000 (JIS-R6001).
